(19) United States
(12) Patent Application Publication
(10) Pub. No.: US 2010/0082204 A1
(43) Pub. Date: Apr. 1, 2010

(54) INVERTED PENDULUM TYPE MOVING MECHANISM

(76) Inventors: Daisuke KIKUCHI, Hitachinaka (JP); Saku Egawa, Toride (JP); Ryosuke Nakamura, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/570,081

(22) Filed: Sep. 30, 2009

(30) Foreign Application Priority Data
Sep. 30, 2008 (JP) 2008-252171

(51) Int. Cl. G06F 19/00

(52) U.S. Cl. 701/41; 701/36

(57) ABSTRACT

An inverted pendulum type moving mechanism, enabling to detect a single-wheel idling when it occurs therein, thereby to maintain a standing condition even in case where an idling maintenance time is long, comprises: left and right wheels; a moving mechanism having traveling motors, which rotationally drive those wheels; an upper body, which is supported on the moving mechanism; and a control apparatus, which controls the moving mechanism, wherein the control apparatus comprises an idling detector unit for the wheels and a traction return detector unit, and executes a double-wheels standing travel control when no idling is detected within the idling detector unit, or a loading-wheel standing control when the idling is detected within the idling detector unit, and further the control apparatus executes an idling wheel control is executed upon the idling wheel for urging traction return, and turns back to the loading-wheel standing control when no traction return is detected within the traction return detector unit, and returns to the double-wheels standing travel control when traction return is detected within the traction return detector unit, and thereby executing an idling treatment control.

### BACKGROUND OF THE INVENTION

The present invention relates to a moving mechanism of an inverted pendulum type, being able to maintain standing position even when idling (herein, it is defined that a wheel rotates in the state that a force does not travel to the road because of a wheel being floated) occurs due to slipping (hereinafter, being called only “idling”) on one side of wheels.

Description relating to an inverted pendulum type moving mechanism, which is symmetric left to right is given in the following Patent Document 1, and that relating to a moving mechanism to be applied as a moving means for a human being is given in the following Patent Document 2, respectively.

The inverted pendulum type moving mechanism of the Patent Document 1 comprises a pair of wheels, a wheel axle, being provided to bridge over the both wheels, an upper body supported by the wheel axle, a wheel driving apparatus, and a control apparatus for controlling the wheels. An inclination of the moving mechanism is detected by an inclination angle measuring means of the upper body, and a rotation angle of the wheel is detected by a wheel rotation angle detecting means. The wheel driving means calculates out a driving torque by inserting the detected inclination angle of the upper body and the rotation angle of the wheel, into a control input equation for formula, which are determined in advance, so as to control a wheel driving motor; i.e., executing a two-wheels or double-wheels standing control.

In the Patent Document 2, during the time when the inverted pendulum type moving mechanism runs with standing, acceleration of the both wheels is calculated for each control cycle or period, and if that acceleration is larger than the maximum acceleration available under the condition of loading the friction (or, traction) between the wheels and a floor, then it is determined that those wheels are slipping. When the friction from the floor loads upon the idling wheel, a torque free control is executed, so as to follow that. Further, when it is determined that a moment of inertia, which is calculated from driving torque and acceleration of the slipping wheel for each control cycle, during when detecting the slipping, is larger than the moment of inertia of the idling wheels, then a traction control is executed; i.e., turning back to the double-wheels standing control with an assumption that the traction is returned.

[Patent Document 1] Japanese Patent Laying-Open No. Sho 63-305082;

[Patent Document 2] U.S. Pat. No. 6,288,505 specification; and

[Patent Document 3] Japanese Patent Laying-Open No. 2007-319991 (2007).

### BRIEF SUMMARY OF THE INVENTION

When the inversed pendulum type moving mechanism is executing a standing control for maintaining the standing condition, and in particular, when accompanying a traveling movement thereof, there sometimes occurs a phenomenon that one of the wheels slips or idles.

The occurrence of this idling is a phenomenon indicating that the driving torque to the wheels comes to be larger than the traction due to reaction torque between the floor and the wheels, which can be estimated from, originally or fundamentally, due to the following phenomena: (a) a sudden lowering of a coefficient of the traction of the floor, during the traveling; (b) an abrupt acceleration/deceleration of the wheels; (c) floating of the wheels, for a certain time period, accompanying with running-on/falling-down of the wheels onto/from very small unevenness or roughness on the floor, etc.

Regarding this idling wheel, due to reduction of the traction, which is acting from the floor just before idling occurs, a force acting upon a main body of the moving mechanism from the idling wheels, serving to maintain the standing condition of the inversed pendulum type moving mechanism up to now, is reduced, therefore the standing control comes to be unstable, and then sometimes it results into falling down. However, for the purpose of maintaining stable traveling, there is necessity of preventing from the falling down, as far as possible.

For preventing from this falling down accompanying this idling, the followings are necessary: i.e., (d) to execute a control for stimulating an early return of traction of the idling wheels, and (e) to obtain maintenance of the standing condition only with a wheel touching on the ground (i.e., loading) during the time of the idling. Regarding (d), the traction control is described in the Patent Document 2 mentioned above, however regarding (e) no disclosure is made.

As forces acting from the loading wheel onto the upper body of the inversed pendulum type moving mechanism is included a reaction force of traction between the floor and the wheels; however, as forces acting from the idling wheel onto the upper body, there is not included the reaction force, therein. For this reason, a rotational movement is generated around a periphery of a yawing axis; due to unbalance of the forces acting upon the upper body, and this affects an ill influence upon the standing control. In case where the inertia moment is small, in particular, of the upper body of the inversed pendulum type moving mechanism, in relation to the yawing axis thereof, this ill influence comes to be remarkable.

Further, in case where an inclination angle is deep (or, large) when the idling occurs, or in case where the time period of continuing the idling is long, since it is necessary to maintain the standing condition only on the loading wheel, though maintaining the standing condition on the both wheels up to now, there can be considered necessity of increasing the driving torque of that loading wheel.

Also, there is necessity of conducting the detection of the idling, as robustly and certainly, as possible; however, as is in the Patent Document 2, i.e., with a method of detecting the idling with using only the information of rotation angle of the wheel, in relation to the information of movements, it must be done to increase a dimension number of a filter or a threshold value, so as not to respond to a noise component included in the information of rotation angle, and therefore there sometimes occurs a delay in the detection of the idling.

An object according to the present invention is to provide an inversed pendulum type moving mechanism, for enabling to detect the idling on one-side of the wheels of the inversed pendulum type moving mechanism, when it occurs, as soon as possible, and thereby maintaining the standing condition even if the idling continues for a long time.

According to the present invention, for accomplishing the object mentioned above, there is provided an inverted pendulum type moving mechanism, comprising: left and right wheels; a moving mechanism having traveling motors, which rotationally drive those wheels; an upper body, which is supported on said moving mechanism; and a control apparatus, which controls said moving mechanism, wherein said control apparatus comprises an idling detector unit for the wheels and a traction return detector unit, and executes a double-wheels standing travel control when no idling is detected within said idling detector unit, or a loading-wheel standing control when the idling is detected within said idling detector unit, and further said control apparatus executes an idling wheel control is executed upon the idling wheel for urging traction return, and turns back to said loading-wheel standing control when no traction return is detected within said traction return detector unit, and returns to said double-wheels standing travel control when traction return is detected within said traction return detector unit, and thereby executing an idling treatment control.

According to the present invention, it is possible to provide the inverted pendulum type moving mechanism for maintaining the standing condition from a start to an end of generation of idling, thereby not generating the fall-down, by supporting an early traction return to the idling wheel, with detecting single-wheel idling, soon, when it generates, and maintaining the standing condition on the loading wheel, and shifting into the double-wheels loading standing control, as soon as possible, with detecting the traction return when the traction returns.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1A is a front view for explaining the mechanism configuration of a moving robot, according to an embodiment of the present invention;

FIG. 1B is a front view of the moving robot shown in FIG. 1A;

FIG. 1C is a plane (or upper) view of the moving robot shown in FIG. 1A;

FIG. 1D is a plane view for showing change of the position of the moving robot shown in FIG. 1A, upon yawing rotation movement thereof;

FIG. 2 is a control system configuration view of the moving robot shown in FIG. 1A;

FIG. 3 is a flowchart for showing a method for controlling an idling treatment of the robot shown in FIG. 1A;

FIG. 4 is a flowchart for showing a method for detecting the idling by an idling detector unit shown in FIG. 2;

FIG. 5 is a block diagram of a loading wheel standing control shown in FIG. 3; and

FIG. 6 is a flowchart for showing a method for detecting traction turning of a traction turning detector unit shown in FIG. 2.

### DETAILED DESCRIPTION OF THE PREFERRED EMBODIMENTS

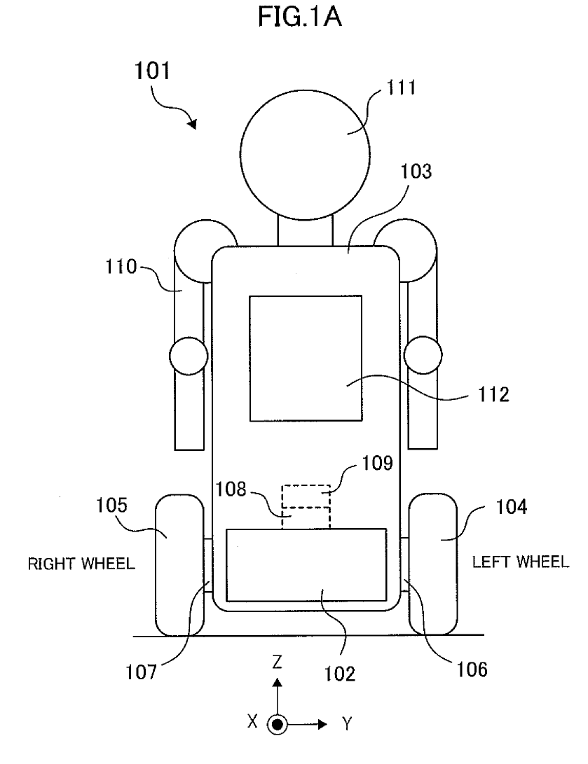

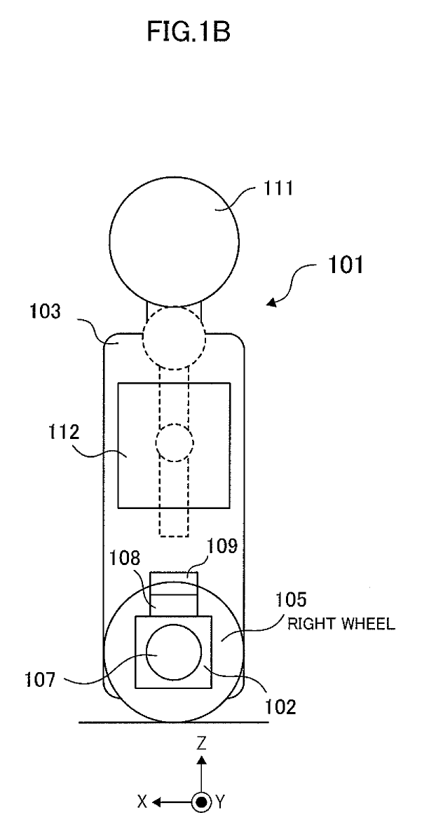

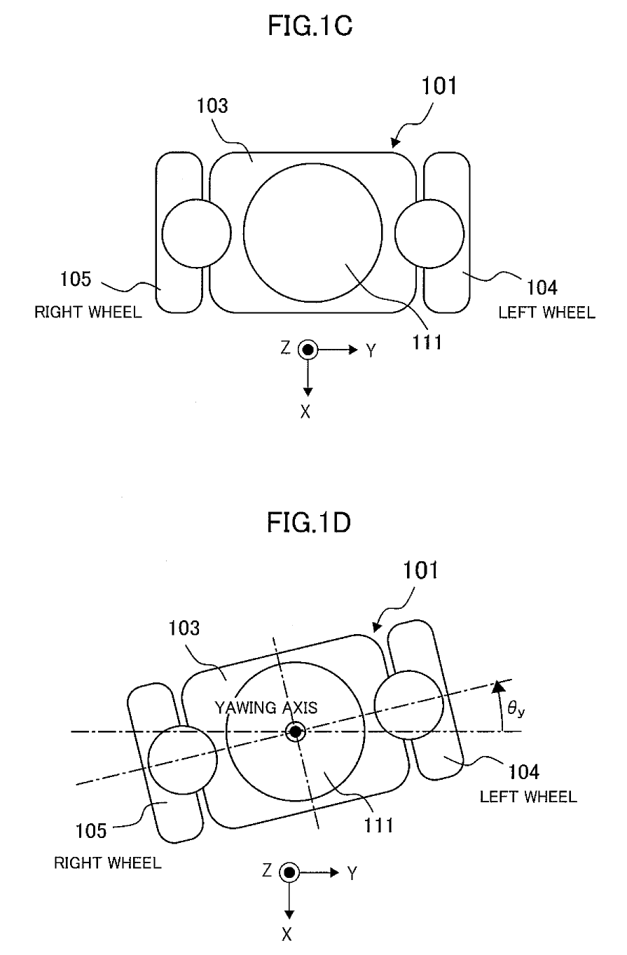

Hereinafter, explanation will be given on an inversed pendulum type moving mechanism, according to the present invention, by referring to the attached drawings, i.e., FIGS. 1A to 6.

First of all, explanation will be made on the structures of the moving robot 101, according to the present embodiment, by referring to FIGS. 1A to 1C. In particular, FIG. 1A is a front view for explaining the structures of the moving robot according to the present embodiment, FIG. 1B a side view of the moving robot shown in FIG. 1A, and FIG. 1C a plane view (or, an upper view) thereof, respectively.

The moving robot 101 is that of an inversed pendulum type, and it can be divided, roughly, into a moving mechanism 102 and an upper body 103.

The moving mechanism 102 comprises a right-hand side wheel 104 and a left-hand side wheel 105, and traveling motors 106 and 107 on both (right and left) sides for rotationally driving those, respectively. The upper body 103 is supported on an upper portion of the moving mechanism 102, to be rotatable. On the upper portion of the moving mechanism 102 are provided an attitude azimuth sensor 108 for detecting an inclination of the upper body 103 upon basis of the vertical direction, and another attitude azimuth sensor 109 for detecting an amount of rotation (or an amount of revolution) of the moving robot on the periphery of a yawing axis. The upper body 103 comprises a working manipulator 110, a working apparatus, such as, a head portion 111 having an interface function with a human being, etc., and a controller 112 for controlling the robot as a whole.

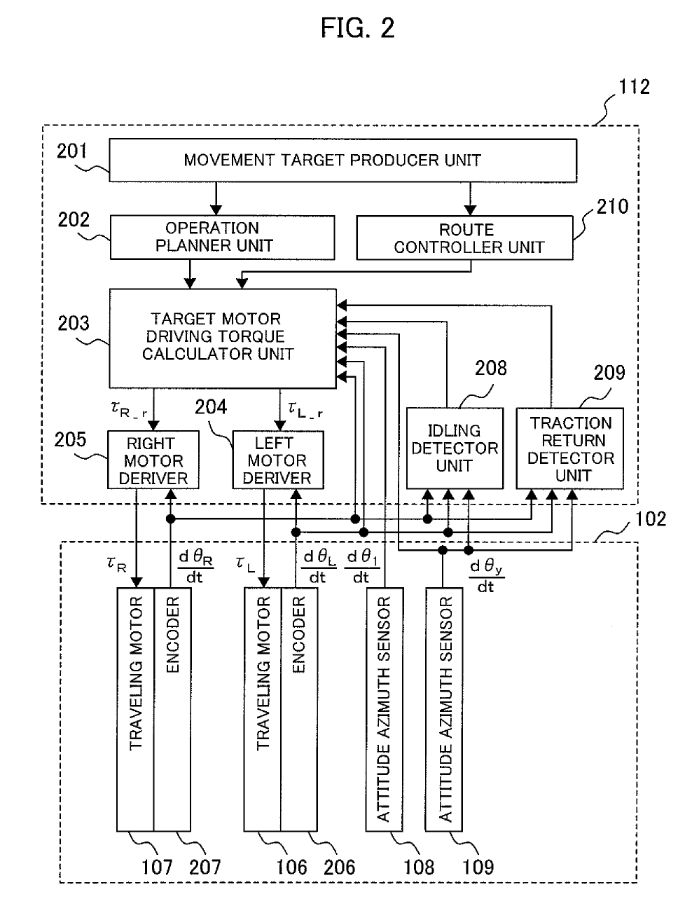

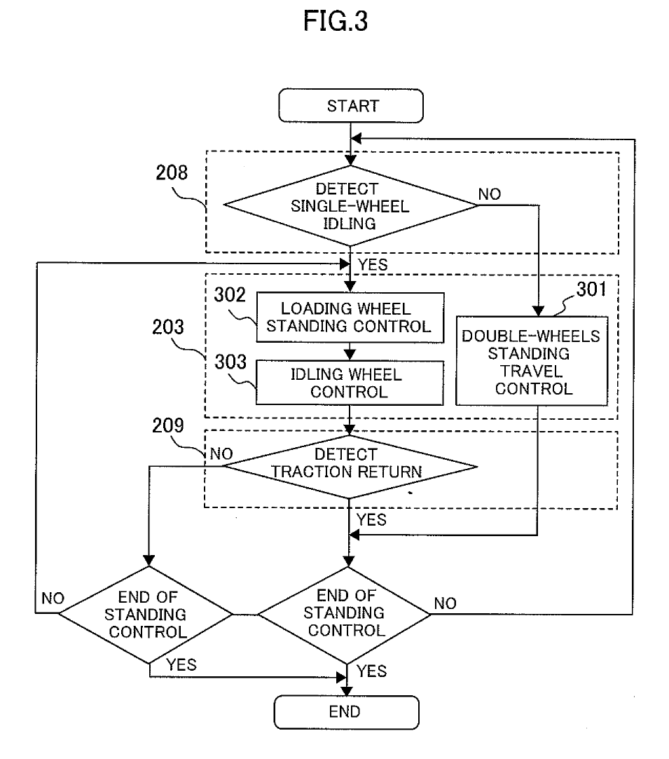

Next, explanation will be made on the configuration of a control system of the moving robot 101, by referring to FIGS. 2 and 3. This FIG. 2 is the configuration view of the control system of the moving robot. FIG. 3 is a control flow for the idling, i.e., for dealing with an occurrence of an idling of wheel. The control apparatus 112 comprises a movement target producer unit 201, an operation planner unit 202, a target motor driving torque calculator unit 203, a left motor driver 204, a right motor driver 205, an idling detector unit, a traction return detector unit 209 and a route controller portion or unit 210.

In the movement target producer unit 201 are produced an arrival position, a moving time, a moving velocity or speed, a maximum moving acceleration, a maximum motor drive torque, etc., i.e., the movement target of the moving robot 101. The operation planner unit 202, upon receipt of the arrival position, the moving time, the moving speed, the maximum moving acceleration, and the maximum motor drive torque from the movement target producer unit 201, produces a target position, a target velocity or speed, a target inclination angle and a moving motor drive torque of the moving robot, for each time along a time sequence. The producing method thereof may use the method, which is shown in the Patent Document 3, for example.

The route controller unit 210, upon obtain of the arrival position from the movement target producer unit 201, produces a route up to the arrival position, and also calculates out target values of rotation angle and target values of rotating angular speed on that route. Hereinafter, those target values of rotation angle and target values of rotating angular speed are called, “target values of rotation”, collectively.

The target motor driving torque calculator unit 23 obtains idling information of the wheel from an idling detector portion or unit 208, tracking return information of the idling wheel from a traction return detector portion or unit 209, a movement target value from the operation planner unit 202, and a rotation target value from the route controller unit 210, respectively.

Further, the target motor driving torque calculator unit 203 obtains angular velocities or speeds “dθ_{L}/dt” and “dθ_{R}/dt” of the left and the right wheels from left and right encoders (i.e., angular speed sensors) 206 and 207, an inclination angular velocity or speed “dθ₁/dt” in the vertical direction of the upper body 103 from the attitude azimuth sensor 108, an angular velocity or speed “dθ_{y}/dt” of yawing rotation, respectively. The target motor driving torque calculator unit 203 designates target motor driving torques “τ_{L}_{_{—}}ᵣ” and “τ_{R}_{_{—}}ᵣ”, to the left and right motor drivers 204 and 205, in accordance with the control flow for dealing with the idling shown in FIG. 3, in each control cycle, with using those information obtained.

Next, the left and right motor drivers 204 and 205 obtain the target motor driving torques “τ_{L}_{_{—}}ᵣ” and “τ_{R}_{_{—}}ᵣ” from the target motor driving torque calculator unit 203, the angular speeds “dθ_{L}/dt” and “dθᵣ/dt” of the left and the right wheels from the left and right encoders 206 and 207, respectively, and control them, respectively, so that the motor driving torques “τ_{L}” and “τ_{R}” of the left and right traveling motors 106 and 107 come to be equal to the target motor driving torques “τ_{L}_{_{—}}ᵣ” and “τ_{R}_{_{—}}ᵣ”.

The target motor driving torque calculator unit 203, like the method for controlling an idling treatment shown in FIG. 3, executes a two-wheels or double-wheels standup traveling control 301 when the idling detector unit 208 detects no idling of the wheel. On the other hand, when the idling detector unit 208 detects an idling of the wheel, it executes a loading-wheel standing control 302 upon the loading wheel, on the side of which non-idling is detected, and thereafter it executes an idling wheel control 303, and receives the information, if the traction of the idling wheel returns or not, within the traction return detector unit 209. In case where the traction does not return, it returns back to the loading-wheel standing control 302 in the next control cycle, and where the traction returns, it turns back a one-wheel or single-wheel idling detection by the idling detector unit 208 in the next control cycle. As the driving torque calculation method in the double-wheels standup traveling control 301 mentioned above may be applied the method disclosed in the Patent Document 3 mentioned above, for example.

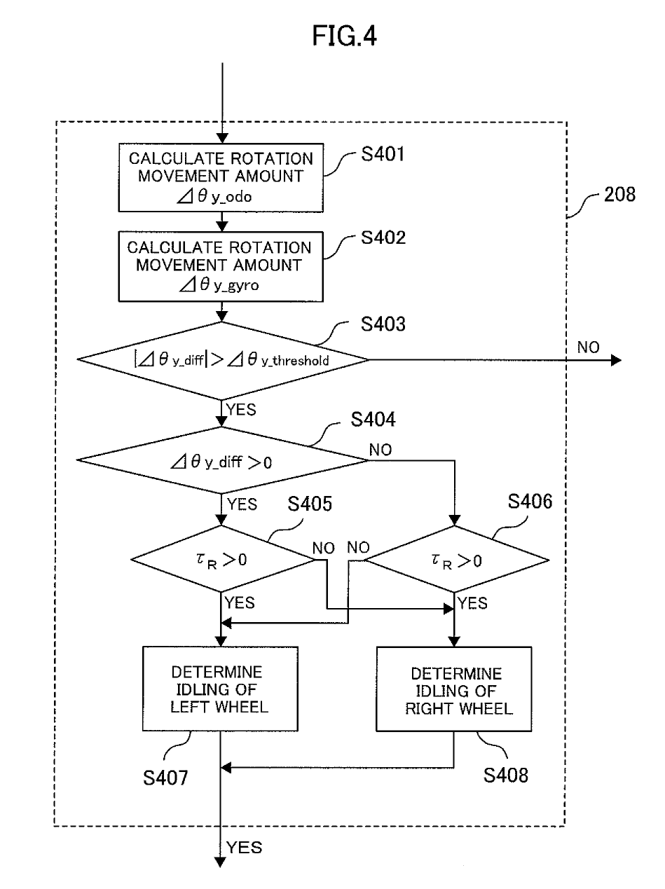

Next, explanation will be made on a method for detecting single-wheel idling within the idling detector unit 208, by referring to a flowchart shown in FIG. 4. As is shown in FIG. 1D, when assuming that an anticlockwise rotation displacement angle of the yawing axis (Z-axis) passing through the center of gravity of the upper body 103 is “θ_{y}” on the XY plane, a rotation displacement angle (i.e., the rotation movement amount) “Δθ_{y}_{_{—}}_{odo}” within a short time-period is calculated by an equation (1), with using wheel angle integration values “Δθ_{L}” and “Δθ_{R}” within a short time-period, which can be calculated from the output signals of the encoders 206 and 207 of the left and right wheels, in a step S401. Herein, “r” in the equation (1) is a wheel radius, and “w” is a tread width of the wheel, respectively.

Δθ_{y}_{_{—}}_{odo}=2r(Δθᵣ−Δθ_{L})/w (Eq. 1)

On the other hand, in a step S402, a rotation displacement angle (i.e., the rotation movement amount) “Δθ_{y}_{_{—}}_{gyro}” within a short time-period, from a short time-period integration value of an output of the attitude azimuth sensor 109. Next, in a step S403 is calculated a difference “Δθ_{y}_{_{diff}}=a·Δθ_{y}_{_{—}}_{gyro}−Δθ_{y}_{_{—}}_{odo}” between “Δθ_{y}_{_{—}}_{odo}” and “Δθ_{y}_{_{—}}_{gyro}”, an absolute value thereof is compared with “Δθ_{y}_{_{—}}_{threshold}”, which is determined in advance. Herein, “a” is a weighting coefficient of “Δθ_{y}_{_{—}}_{gyro}” to “Δθ_{y}_{_{—}}_{odo}”.

When sufficient traction is generated on both wheels, the rotation movement amounts of both wheels take values near to each other, then the absolute value of “Δθ_{y}_{_{—}}_{diff}” come to a value less than “Δθ_{y}_{_{—}}_{threshold}”, and then it is determined that the both wheels are loading. On the other hand, when the traction of one of the wheels comes out therefrom, for example, when the left wheel idles, a rotating force generates around the yawing axis because there is no reaction force from the idling wheel to the upper body, and then “Δθ_{y}_{_{—}}_{gyro}” is a positive value, when the driving torque “τ_{R}” of the right motor has a positive value, and is a negative value, when “τ_{R}” has a negative value.

With the idling wheel, “dθL/dt” takes an abrupt acceleration if the driving torque “τ_{L}” of the left motor has the positive value, or it takes abrupt deceleration if “τ_{L}” has the negative value, and therefore, “Δθ_{y}_{_{—}}_{odo}” calculated from the equation (1) has a large value in the opposite direction, with respect to the actual rotation movement amount on the surface thereof. Thus, “Δθ_{y}_{_{—}}_{odo}” and “Δθ_{y}_{_{—}}_{gyro}” take the values of polarities, being opposite to each other, when an idling occurs, and in the step S403, the absolute value of “Δθ_{y}_{_{—}}_{diff}” has a value larger than “Δθ_{y}_{_{—}}_{threshold}”, soon, just after the idling occurs, then it is possible to detect the idling, quickly, than when using only the rotation angular speed of the wheel.

In case where the condition of the step S403 is satisfied with, determination is made on the polarity of “Δθ_{y}_{_{—}}_{diff}” in the step S404, and further through the determination of polarity in steps S405 and S406, it is determined, which one of the wheels takes the idling (S407 and S408).

Next, explanation will be made on a method for calculating a motor driving torque of the moving robot 101, in the loading-wheel standing control 302 shown in FIG. 3. Hereinafter, though there is shown an example where the left wheel 104 takes the idling, however it is also possible to deal with the similar method, in case where the right wheel 105 takes the idling.

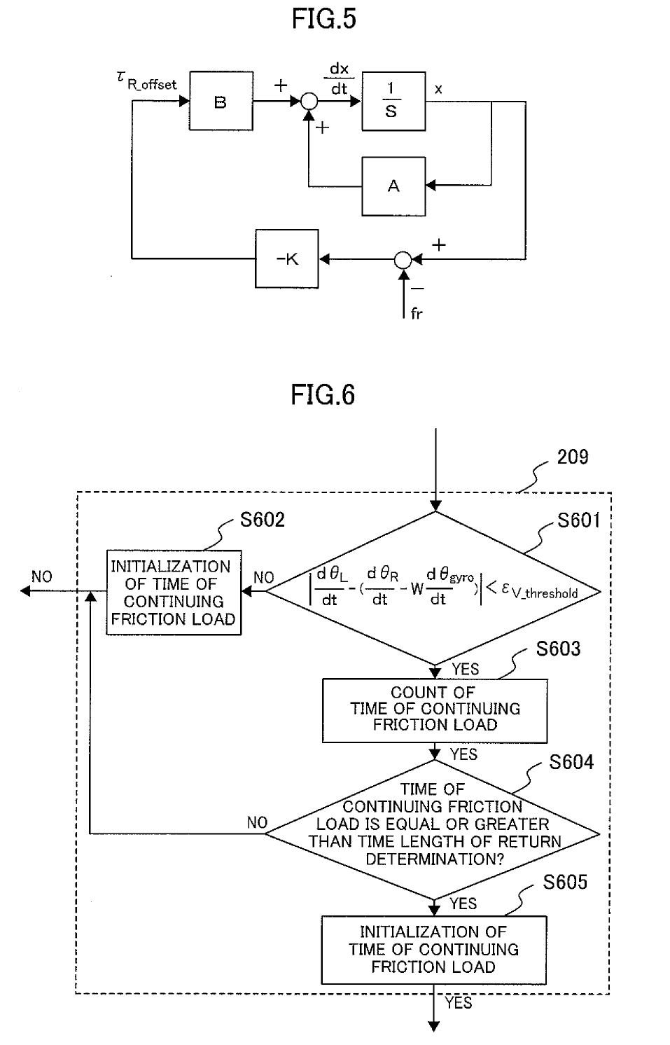

In the loading-wheel standing control 302, a motor driving torque “τ_{R}_{_{—}}ᵣ” is calculated, in relation to the loading wheel (i.e., the right wheel) 105, which is necessary for maintaining the standing condition of the moving robot 101, through a control system shown in FIG. 5. In the present embodiment, regarding a quantity of state relating to the movement of the moving mechanism 102, which is used in FIG. 5, it is assumed that movement information of the loading wheel, removing a component of rotation movement around the yawing axis of the upper body 103 accompanying the single-wheel idling, therefrom. Further, a feedback gain necessary for the standing control is determined by taking the single-wheel standing condition into the consideration thereof. Hereinafter, explanation will be made on calculating methods of this state variable and a feedback gain matrix “K”.

With the movement information relating to the moving mechanism 102, which is used in the loading-wheel standing control 302, correction or compensation speed information (correction angular speed) “dθ_{c}/dt” excepting the rotation movement component therefrom, is calculated in accordance with the following equation, with using wheel rotation angular speed or information “dθ_{R}/dt”, which is obtained from the encoder 207 of the loading wheel 105, and rotation movement information “dθ_{y}/dt” around the yawing axis of the upper body 103, which is obtained from the attitude azimuth sensor 109.

$$\frac{d {θ}_{c}}{d t} = \frac{d {θ}_{R}}{d t} - \frac{w}{2 r} \frac{d {θ}_{y}}{d t} \qquad ( Eq . 2 )$$

In the standing control system shown in FIG. 5, with using the speed information and the integrated value thereof, which can be obtained from the equation (2), as the quantity of state, it is possible to bring an inclusion or mixing of the component of yawing rotation movement of the upper body 103, resulting into an instability of the control system, to be small. This is effective, in particular, when a control cycle of the control apparatus 112 is long (i.e., late) or when an inertia moment around the yawing axis of the upper body 103 is small.

Next, steps will be shown, for obtaining the feedback gain “K” in the view of the block diagram of the loading-wheel standing control 302 shown in FIG. 5. During the time when one of the wheels of the moving robot is in idling, a balancing relationship of forces, necessary for maintaining the standing condition, is considered on the XZ plane passing through the center of gravity of the upper body 103 in FIG. 1B, assuming that completely no traction loads on the idling wheel.

Herein, it is assumed that the moving robot 101 is constructed with the moving mechanism 102 and the upper body 103, and that the moving mechanism 102 comprises the left and right wheels 104 and 105, the left and right traveling motors 106 and 107, and the axles connecting those wheels and the traveling motors, wherein a mass per one (1) wheel is “m₀” and an inertia moment around the wheel is “J₀”. The upper body 103 is assumed to be parts other than those mentioned above, and the mass thereof is “m₀”, the inertia moment relating to an inclination of the center of gravity, seeing it from the wheel axle is “J₁”, and it is represented by a mass point having the distance between the wheel axle and the center of gravity “l”, respectively. It is also assumed that the radius of the wheel is “r”, viscosity resistance between each wheel driver unit and the upper body 103 is “D”, respectively. Those parameters “m₀”, “m₁”, “J₀”, “J₁”, “l”, “r” and “D” may be obtained by measuring an actual machine or calculated from the design values.

On the XZ plane, rotation angles defined between the wheels 104 and 105 and the upper body 103 are “θ_{L}” and “θ_{R}”, and an inclination of the upper body 103 from the vertical direction is “θ₁”, respectively. And, it is assumed that the driving torques of the traveling motors 106 and 107 are “τ_{L}” and “τ_{R}”, respectively. For the purpose of simplification, a total mass of the moving robot 101 is assumed to be “Mₐₗₗ=m₁+2m₀”.

In this instance, a linear abbreviation or simplicity (approximation) of the equations of motion in relation to “θ_{c}”,which is obtained by integrating correction rotation angular speed “dθ_{c}/dt” of the loading wheel mentioned above, is shown by the following equations (3a) and (3b).

$$\begin{matrix}\{ {J}_{0} + {M}_{all} {r}^{2} \} \frac{{d}^{2} {θ}_{c}}{d {t}^{2}} + \{ {J}_{0} + {M}_{all} {r}^{2} + {m}_{1} rl \} \frac{{d}^{2} {θ}_{1}}{d {t}^{2}} = {t}_{R} - D \frac{d {θ}_{R}}{d t} & ( Eq . 3 a ) \\ \{ {J}_{0} + {M}_{all} {r}^{2} + {m}_{1} rl \} \frac{{d}^{2} θ c}{d {t}^{2}} + {J}_{0} \frac{{d}^{2} {θ}_{L}}{d {t}^{2}} + \{ {J}_{1} + 2 {J}_{0} + {M}_{all} {r}^{2} + {m}_{1} {rl}^{2} + 2 {m}_{1} rl \} \frac{{d}^{2} {θ}_{1}}{d {t}^{2}} = {m}_{1} gl {θ}_{1} & ( Eq . 3 b )\end{matrix}$$

Further, expressing the equations (3a) and (3b) in the state space is the following equation (4). However, it is assumed that “τ_{R}_{_{—}}_{offset}=τ_{R}−D·dθ_{R}/dt”, and an influence of a reaction torque upon the upper body due to the angular acceleration of the idling wheel is neglected with an assumption that it is small.

$$\begin{matrix}\frac{d x}{d t} = {A}_{X} + {Bt}_{R\_offset} & ( Eq . 4 ) \\ x = [ \begin{matrix}{θ}_{c} \\ {θ}_{1} \\ \frac{d {θ}_{c}}{d t} \\ \frac{d {θ}_{1}}{d t}\end{matrix} ] & \\ A = [ \begin{matrix}{O}_{2 \times 2} & {I}_{2 \times 2} \\ - {α}^{- 1} β & {O}_{2 \times 2}\end{matrix} ] & \\ B = [ \begin{matrix}0 \\ 0 \\ - {α}^{- 1} γ\end{matrix} ] & \\ α = [ \begin{matrix}{J}_{0} + {M}_{all} {r}^{2} & {J}_{0} + {M}_{all} {r}^{2} + {m}_{1} rl \\ {J}_{0} + {M}_{all} {r}^{2} + {m}_{1} rl & {J}_{1} + 2 {J}_{0} + {M}_{all} {r}^{2} + {m}_{1} {rl}^{2} + 2 {m}_{1} rl\end{matrix} ] & \\ β = [ \begin{matrix}0 & 0 \\ 0 & - {m}_{1} gl\end{matrix} ] & \\ γ = [ \begin{matrix}1 \\ 0\end{matrix} ] & \end{matrix}$$

Regarding this state space expression, the state feedback gain matrix “K” is calculated upon basis of various control theories, which are already known, and the state feedback control is treated, and thereby the standing condition can be maintained. A view of showing this control system is FIG. 5. However, “fr” in FIG. 5 is an operation plan target value from the operation planner unit 202, and the rotation target value from the route controller portion unit 210 is shut off.

Accordingly, a target driving torque “τ_{R}_{_{—}}ᵣ” relating to the loading wheel 105 results into, as is shown in the following equation (5); i.e., adding a torque canceling the viscosity resistance of the wheel, to summation of “θ_{c}”, “θ₁”, “dθ_{c}/dt” and “dθ₁/dt” multiplied by each of the components, “k₁”, “k₂”, “k₃” and “k₄” of the state feedback gain matrix “K”.

$${t}_{R\_offset} = {t}_{R\_r} D \cdot \frac{d {θ}_{R}}{d t} = [ {k}_{1} , {k}_{2} , {k}_{3} , {k}_{4} ] [ \begin{matrix}{θ}_{c} \\ {θ}_{1} \\ \frac{d {θ}_{c}}{d t} \\ \frac{d {θ}_{1}}{d t}\end{matrix} ] \\ ∴ {t}_{R\_r} = [ {k}_{1} , {k}_{2} , {k}_{3} , {k}_{4} ] [ \begin{matrix}{θ}_{c} \\ {θ}_{1} \\ \frac{d {θ}_{c}}{d t} \\ \frac{d {θ}_{1}}{d t}\end{matrix} ] + D \cdot \frac{d {θ}_{R}}{d t} \qquad ( Eq . 5 )$$

As was mentioned above, by treating the state feedback control, which can be expressed in FIG. 5 with using the feedback gain matrix “K” obtained from the state space expression of the equation (4), considering the correction rotation angular speed “dθ_{c}/dt” and the integrated value “θ_{c}” thereof at a point just below the center of gravity of the upper body 103 as the state quantities relating thereto, there can be built up a control system enabling to maintain the standing condition for longer time, comparing to the standing control presuming the standing condition loading on the both wheels.

Next, explanation will be made on the idling wheel control 303 and the traction return detector unit 209 shown in FIG. 3. In the idling wheel control 303, the traction return is urged and also an easy traction return is required. Then, according to the present embodiment, control is executed, as is shown in the following equations (6a) and (6b).

$$\begin{matrix}{t}_{L\_r} = D \cdot \frac{d {θ}_{L\_ref}}{d t} - r \cdot {F}_{friction} & ( Eq . 6 a ) \\ \frac{d {θ}_{L\_ref}}{d t} = \frac{d {θ}_{R}}{d t} - \frac{w}{r} \frac{d {θ}_{y}}{d t} & ( Eq . 6 b )\end{matrix}$$

Herein, “dθ_{L}_{_{—}}_{ref}/dt” is a relative speed between a floor and the idling wheel, which can be obtained by the equation (6b), from the angular speed “dθ_{R}/dt” of the loading wheel and the attitude angular speed (i.e., the rotation angular speed) “dθ_{y}/dt”. “F_{friction}” is a desired detection amount of traction return, and it is set to be a value smaller than “D·θ_{L}_{_{—}}_{ref}/dt”. In this instance, the equation of motion of the idling wheel comes to the following equation (7).

$${J}_{0} ( \frac{{d}^{2} {θ}_{L}}{d {t}^{2}} + \frac{{d}^{2} {θ}_{1}}{d {t}^{2}} ) = D ( \frac{d {θ}_{L\_ref}}{d t} - \frac{d {θ}_{L}}{d t} ) - {rF}_{friction} \qquad ( Eq . 7 )$$

With this equation of motion, it can be seen that it comes close to the speed, substantially being slow than the relative speed between the floor surface by “(r·F_{friction})/D”, if setting up a torque instruction to be like the equation (6a) and (6b). With this, the friction coefficient comes close to the static friction coefficient, when friction force acts between the floor surface and the idling wheel, and therefore the traction return is urged.

With the idling wheel control 303, since the idling wheel angular speed “r·dθ_{L}/dt” comes to be coincident with the relative speed between the floor, automatically, when the friction force loads, being equal or higher than “F_{friction}”, then it can be determine that the traction equal or higher than “F_{friction}” returns if the idling wheel angular speed “r·dθ_{L}/dt” comes to be equal to the relative speed between the floor, in the value thereof.

However, there can be a situation or condition where the relative speed between the idling wheel speed and the floor comes to be coincident with, temporarily, when the idling is accelerated once just after the idling generates, and thereafter the idling wheel control 303 functions, i.e., when the idling wheel is decelerated. Then, according to the present embodiment, the traction return detector unit 209 detects the traction return in accordance with a flowchart shown in FIG. 6.

First of all, within each control cycle of the control apparatus 112, in S601, when it is determined that the difference between the idling wheel speed “(dθ_{R}/dt−w·dθ_{gyro}/dt)”, which is calculated out from the idling wheel speed “dθ_{R}/dt” and the attitude azimuth sensor output “dθ_{gyro}/dt”, and “dθ_{L}/dt” is less than a threshold value “ε_{V}_{_{—}}_{threshold}”, it is determined that friction force loads, being equal or larger than “F_{friction}”, in S603 is made a counting on the time during when the friction force continues, and then in S604, it is determined on whether the friction loading continuation time is equal or greater than a time length, or not, enough for determination of the traction return. When determining the traction return, in S605 is initialized the friction loading continuation time. If determining that the condition of S601 is not satisfied, and then it is determined that the friction force does not load, and then the friction loading continuation time is initialized in S602. In case where the condition of S604 is not satisfied while satisfying the condition of S601, the flow returns to a nest control cycle while maintaining the present friction loading continuation time. A return determining time length of S604 is determined, during the deceleration of the idling wheel when it gets out from the traction, to correspond to a value larger than a time period satisfying the condition of S601, temporarily. It is assumed that the friction loading continuation time is automatically initialized when the moving robot 101 starts the operation thereof. With the embodiment mentioned above, it is possible to detect the traction return of the idling wheel, with high accuracy.

As was fully mentioned above, according to the present embodiment, within the inverted pendulum type moving mechanism, it is possible to detect generation of idling of one wheel, quickly, by comparing the revolution amount (or, the rotation amount), which is always calculated out from the rotation difference between the left and right wheels, and the revolution amount, which is calculated out from the attitude azimuth sensor. During the time when detecting, onto the loading wheel is applied the standing control, being derived from the equation of motion presuming on the single-wheel loading and applying the movement information of the loading wheel, but excepting the revolution motion component around the yawing axis of the upper body accompanying the single-wheel idling, as the quantity of state. The idling wheel is controlled upon basis of the relative speed between the idling wheel and the floor, the friction force expected between the floor and the idling wheel, the radius of the wheel, the viscosity resistance value of the wheel, etc., so that the traction return and the detection thereof are supported. If the angular speed of the idling wheel comes to be coincident with the moving speed of the inverted pendulum type moving mechanism, it is determined that the traction of the idling wheel has been returned, and with returning to the double-wheels standing control, it is possible to maintain a stable standing condition even during the time when the idling occurs on one wheel, and thereby to suppress the fall-down thereof.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. An inverted pendulum type moving mechanism, comprising:
left and right wheels;
a moving mechanism having traveling motors, which rotationally drive those wheels;
an upper body, which is supported on said moving mechanism; and
a control apparatus, which controls said moving mechanism, wherein
said control apparatus comprises an idling detector unit for the wheels and a traction return detector unit, and executes a double-wheels standing travel control when no idling is detected within said idling detector unit, or a loading-wheel standing control when the idling is detected within said idling detector unit, and further
said control apparatus executes an idling wheel control is executed upon the idling wheel for urging traction return, and turns back to said loading-wheel standing control when no traction return is detected within said traction return detector unit, and returns to said double-wheels standing travel control when traction return is detected within said traction return detector unit, and thereby executing an idling treatment control.

2. The inverted pendulum type moving mechanism, as is described in the claim 1, wherein said loading-wheel standing control is executed upon basis of information of an angular speed sensor, which can detect a rotation movement of the loading wheel, equipped with said moving mechanism, information of a first attitude azimuth sensor, which can detect an inclining angular movement of said upper body to a vertical direction, equipped with said upper boy, and information of a second attitude azimuth sensor, which can detect a rotation angular movement of said upper body around a yawing axis thereof, equipped with said upper body.

3. The inverted pendulum type moving mechanism, as is described in the claim 2, wherein the information of said angular speed sensor and the information of said second attitude azimuth sensor are so as to be movement information of said loading wheel excepting a rotation movement component around the yawing axis of said upper body, to be applied in said standing condition control.

4. The inverted pendulum type moving mechanism, as is described in the claim 1, wherein said idling detector unit detects the idling of said wheel, by comparing a difference value between an amount of the yawing rotation movement calculated from a difference between information of said angular speed sensor, which can detect each of rotation movements of said left and right wheels, and an amount of the yawing rotation movement calculated from information of said attitude azimuth sensor equipped with said upper body, which can detect the yawing rotation movement, with a threshold value.

5. The inverted pendulum type moving mechanism, as is described in the claim 1, wherein said idling wheel control applies a value being obtained by subtracting a value obtained with multiplying a desired amount of lowest return traction by a wheel radius, from a value obtained with multiplying a relative speed between the idling wheel and a floor, which is calculated from information of said angular speed sensor, equipped with said moving mechanism and being able to detect the rotation movement of the loading wheel and information of said attitude azimuth sensor, equipped with said upper body and being able to detect the yawing rotation movement, by viscosity resistance of the wheel, as a driving torque onto the idling wheel.

6. The inverted pendulum type moving mechanism, as is described in the claim 1, wherein said traction return detector unit determines that the traction is returned when a speed of the idling wheel and a time-period of continuing friction load, in which the relative speed between the idling wheel and the floor is within a certain threshold value exceed a return determining time length.
